(19) United States
(12) Patent Application Publication
(10) Pub. No.: US 2026/0062988 A1
(43) Pub. Date: Mar. 5, 2026

(54) DECORATIVE GARAGE DOOR WINDOW ASSEMBLY

(71) Applicant: Prime-Line Products, LLC, Redlands, CA (US)

(72) Inventor: Karen Arduini, Redlands, CA (US)

(21) Appl. No.: 18/824,565

(22) Filed: Sep. 4, 2024

(51) Int. Cl. E06B 7/30; E06B 3/66

(52) U.S. Cl. CPC E06B 7/30; E06B 3/6604

(57) ABSTRACT

A decorative garage door window includes a panel frame, a film positioned behind the panel frame to resemble a window on a garage door, and a plurality of magnetic strips attached to the panel frame and adapted to be mounted to the garage door.

### BACKGROUND OF THE INVENTION

### 1. Field of the Invention

The present invention relates generally to garage door windows and, more particularly to, a decorative garage door window assembly.

### 2. Description of the Related Art

It is known to provide garage doors with windows to let light through the garage door. Typically, these windows are a permanent structure in the garage door. Over time, these garage door windows may allow air to escape around them into the garage.

It is known to provide metallic garage doors that do not have windows in them. As such, these garage doors cannot let in light. In addition, the garage doors are generally planar and have no decorative appearance other than a color of the garage door.

Accordingly, it is desirable to provide a decorative garage door window assembly for a garage door that is removably attached to the garage door. It is also desirable to provide a decorative garage door window assembly for use with existing garage doors. Therefore, there is a need in the art to provide a decorative garage door window assembly that meets at least one of these desires.

### SUMMARY OF THE INVENTION

Accordingly, the present invention provides a decorative garage door window assembly including a panel frame and a film to resemble a window positioned behind the panel frame. The decorative garage door window assembly also includes a plurality of magnetic strips attached to the panel frame adapted to be mounted to the garage door.

One advantage of the present invention is that a new decorative garage door window assembly is provided for a garage door. Another advantage of the present invention is that the decorative garage door window assembly has a raised panel frame and a magnetic sheet film to resemble a window positioned behind the raised panel frame to simplify construction and save cost. Yet another advantage of the present invention is that the decorative garage door window assembly has a plurality of magnetic strips attached to the back side of the raised panel frame to attach to a metallic garage door.

These and other objects, advantages, and features of the present invention will become better understood from the following detailed description of one exemplary embodiment of the present invention that is described in conjunction with the accompanying drawings.

### BRIEF DESCRIPTION OF THE DRAWINGS

FIG. 1 is a perspective view of a decorative garage door window assembly for a garage door constructed according to the present invention.

FIG. 2 is a front view of the decorative garage door window assembly, according to the present invention, of FIG. 1.

FIG. 3 is a side view of the decorative garage door window assembly, according to the present invention, of FIG. 1.

FIG. 4 is an end view of the decorative garage door window assembly, according to the present invention, of FIG. 1.

### DESCRIPTION OF THE PREFERRED EMBODIMENT(S)

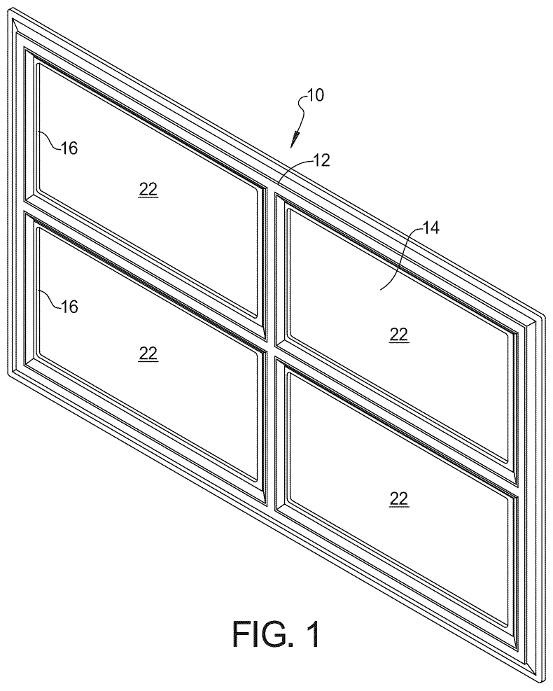

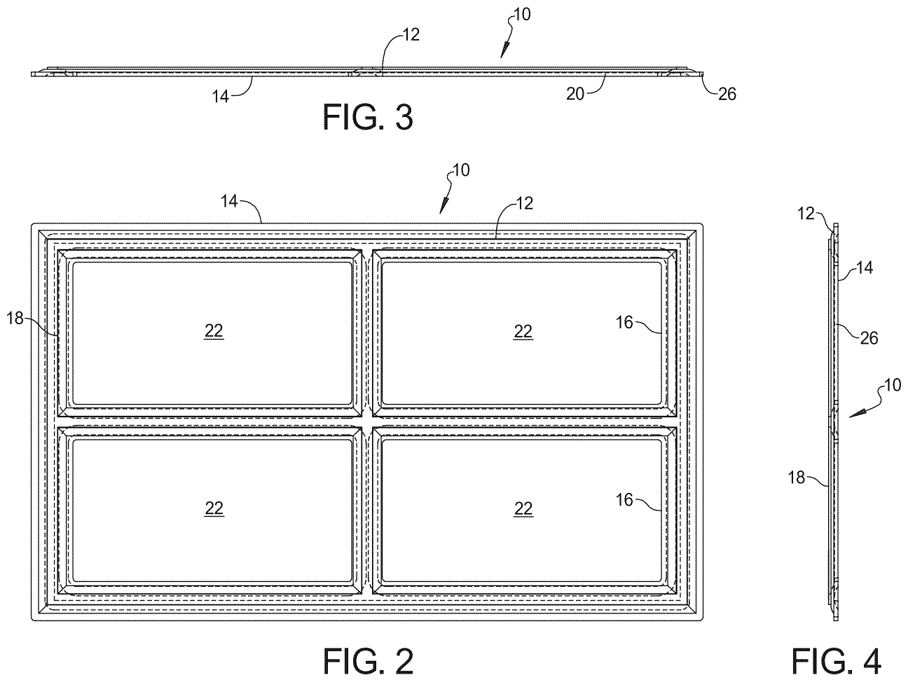

Referring to the drawings, one embodiment of a decorative garage door window assembly 10, according to the present invention, for a garage door (not shown) is shown in FIGS. 1-4. The decorative garage door window assembly 10 includes a panel frame 12 and a film 14 positioned behind the panel frame 12 to resemble a window on the garage door. In one embodiment illustrated in the figures, the panel frame 12 is generally rectangular in shape. In other embodiments, the panel frame 12 may have various shapes, for example, a shape that forms an Arch or Sunburst. The panel frame 12 has a series of openings 16 to form at least one or more individual or discrete window openings. The panel frame 12 has a front side 18 that is raised to provide a decorative appearance similar to a molding. The panel frame 12 also has a back side 20 opposite the front side 18. The panel frame 12 may be manufactured in multiple colors and textures such as grain and smooth. The panel frame 12 may be made of a suitable material such as metal or plastic. It should be appreciated that the panel frame 12 has a predetermined height and width that will vary depending on the length, height, and/or width of sections of the garage door.

The film 14 is a magnetic sheet to resemble a window and is positioned on the back side 20 of the panel frame 12. In one embodiment illustrated in the figures, the film 14 is generally rectangular in shape. In other embodiments, the film 14 may have various shapes, for example, a shape that forms an Arch or Sunburst. The film 14 is attached to the panel frame 12 by a suitable mechanism such as an adhesive. The film 14 may be manufactured in multiple colors and textures such as frosted and smooth. In one embodiment, the film 14 has a front side 22 that is frosted and a back side 24 opposite the front side 22 that is magnetic. The film 14 has a predetermined thickness, height, and width. It should be appreciated that the shape of the film 14 matches the shape of the panel frame 12. It should also be appreciated that the film 14 is disposed behind the openings 16 to resemble windows.

The decorative garage door window assembly 10 further includes a plurality of magnetic strips 26. The magnetic strips 26 are generally rectangular in shape, but may be any suitable shape. The magnetic strips 26 may be one continuous magnetic strip or discreet magnetic strips disposed at various locations along the back side 20 of the panel frame 12. The magnetic strips 26 are attached to the back side 20 of the panel frame 12 by a suitable mechanism such as an adhesive. It should be appreciated that the magnetic strips 26 have a predetermined adhesion holding force such as 415 g/cm² and a predetermined magnetic flux such as 1600 Gs. It should also be appreciated that the garage door is metallic and the decorative garage door window assembly 12 may be magnetically adhered to the garage door.

In operation, the decorative garage door window assembly 10 is assembled and attached to the metallic garage door by the magnetic strips 26. The decorative garage door window assembly 10 provides a decorative window due to the raised appearance, color, and texture of the panel frame 12 and the color and texture of the film 14. It should be appreciated that the decorative garage door assembly 10 is removable and re-positionable on the metallic garage door to resemble a window of the garage door.

The present invention has been described in an illustrative manner. It is to be understood that the terminology, which has been used, is intended to be in the nature of words of description rather than of limitation.

Many modifications and variations of the present invention are possible in light of the above teachings. Therefore, the present invention may be practiced other than as specifically described.

What is claimed is:

1. A decorative garage door window assembly comprising:
a panel frame;
a film positioned behind the panel frame to resemble a window on a garage door;
a plurality of magnetic strips attached to the panel frame and adapted to be mounted to the garage door.

2. The decorative garage door window assembly of claim 1 wherein the panel frame is raised on one side thereof.

3. The decorative garage door window assembly of claim 1 wherein the panel frame has at least one opening extending therethrough.

4. The decorative garage door window assembly of claim 1 wherein the film is a magnetic sheet.

5. The decorative garage door window assembly of claim 1 wherein the film has a predetermined color.

6. The decorative garage door window assembly of claim 1 wherein the film has a predetermined texture.

7. The decorative garage door window assembly of claim 1 wherein the panel frame has a predetermined color.

8. The decorative garage door window assembly of claim 1 wherein the panel frame has a predetermined texture.

9. The decorative garage door window assembly of claim 1 wherein the panel frame is made of metal.

10. The decorative garage door window assembly of claim 1 wherein the panel frame is made of plastic.

11. The decorative garage door window assembly of claim 1 wherein the panel frame has a predetermined shape.

12. The decorative garage door window assembly of claim 11 wherein the film has a predetermined shape that matches the predetermined shape of the panel frame.

13. The decorative garage door window assembly of claim 1 wherein the magnetic strips have a predetermined shape.

14. The decorative garage door window assembly of claim 1 wherein the magnetic strips are one of a continuous magnetic strip and discreet magnetic strips disposed in various locations along a back side of the panel frame.

15. The decorative garage door window assembly of claim 14 wherein the magnetic strips are attached to the back side of the panel frame by an adhesive.

16. A decorative garage door window assembly comprising:
a panel frame having a predetermined shape and a front side being raised;
a magnetic sheet film positioned behind the panel frame to resemble a window on a garage door; and
a plurality of magnetic strips attached to the panel frame and adapted to be mounted to the garage door.

17. The decorative garage door window assembly of claim 16 wherein the panel frame has at least one opening extending therethrough.

18. The decorative garage door window assembly of claim 16 wherein the film has a predetermined shape that matches the predetermined shape of the panel frame.

19. The decorative garage door window assembly of claim 16 wherein the magnetic strips are one of a continuous magnetic strip and discreet magnetic strips disposed in various locations along a back side of the panel frame.

20. A decorative garage door window assembly comprising:
a panel frame having a predetermined shape and a front side being raised, wherein the panel frame has at least one opening extending therethrough;
a magnetic sheet film positioned behind the panel frame to resemble a window on a metallic garage door, wherein the film has a predetermined shape that matches the predetermined shape of the panel frame; and
a plurality of magnetic strips adhesively attached to a back side of the panel frame and adapted to be mounted to the metallic garage door, wherein the magnetic strips are one of a continuous magnetic strip and discreet magnetic strips disposed in various locations along a back side of the panel frame.
